(19) United States
(12) Patent Application Publication
(10) Pub. No.: US 2010/0060834 A1
(43) Pub. Date: Mar. 11, 2010

(54) COPOLYIMIDE, LIQUID CRYSTAL ALIGNING LAYER COMPRISING THE SAME , AND LIQUID CRYSTAL DISPLAY COMPRISING THE SAME

(76) Inventors: Xing-Zhong Fang, Daejeon Metropolitan City (KR); Kyung-Jun Kim, Daejeon Metropolitan City (KR); Byung-Hyun Lee, Daejeon Metropolitan City (KR); Jung-Ho Jo, Gyeonggi-do (KR); Dong-Hyun Oh, Daejeon Metropolitan City (KR); Wan-Hee Goh, Seoul (KR); Sang-Kook Kim, Seoul (KR); Hye-Ran Seong, Seoul (KR); Hye-Won Jeong, Daejeon Metropolitan City (KR); Yun-Jeong Lee, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/312,191

(22) PCT Filed: Jan. 7, 2008
(86) PCT No.: PCT/KR2008/000068

§ 371 Date: Apr. 29, 2009

(30) Foreign Application Priority Data
Jan. 9, 2007 (KR) 10-2007-0002387

(51) Int. Cl. G02F 1/1337; C08F 22/40; C08F 26/00; B05D 3/06; B32B 5/00; C09K 19/00

(52) U.S. Cl. 349/123; 526/262; 526/248; 427/553; 428/220; 428/1.26

(57) ABSTRACT

The present invention relates to a novel polyimide copolymer, a method of preparing the polyimide copolymer, a liquid crystal aligning layer including the polyimide copolymer, a method of producing the liquid crystal aligning layer, and a liquid crystal display including the liquid crystal aligning layer. The liquid crystal aligning layer that includes the polyimide copolymer according to the present invention is advantageous in that when ultraviolet rays are radiated on movable chains of the polyamic acid copolymer to perform alignment before a polyimide copolymer is imidized and heat treatment is then performed to conduct imidization, thermal stability is excellent, residual images are not formed, and alignment of liquid crystals is excellent.

### TECHNICAL FIELD

The present invention relates to a novel polyimide copolymer, a method of preparing the polyimide copolymer, a liquid crystal aligning layer including the polyimide copolymer, a method of producing the liquid crystal aligning layer, and a liquid crystal display including the liquid crystal aligning layer.

This application claims priority from Korean Patent Application No. 10-2007-2387 filed on Jan. 9, 2007 in the Korean Intellectual Property Office, the disclosure of which is incorporated herein by reference in its entirety.

### BACKGROUND ART

In accordance with the advance in the display industry, a low driving voltage, high resolution, reduction in volume of the monitor, and flatness of the monitor are realized in a liquid crystal display field. Accordingly, demands for liquid crystal displays are significantly growing. In liquid crystal display technologies, it is essential to align liquid crystals in a desired direction.

In the current LCD industry, a contact-type rubbing process is used as a known process of aligning liquid crystals. The rubbing process includes applying a polymer film such as polyimide on a substrate such as glass, and rubbing a surface of the resulting substrate by using fibers such as nylon and polyester in a predetermined direction. Alignment of the liquid crystals by using the above-mentioned contact-type rubbing process is advantageous in that stable alignment ability of the liquid crystals is assured by using a simple process. However, fine dust may be generated or electrostatic discharge (ESD) may occur when the fibroid materials are rubbed with the polymer film, causing the damage to the substrate. Serious problems may occur during the production of liquid crystal panels due to the troubles of the process such as the increased process time and nonuniform rubbing strength resulting from the use of large rolls for the use of enlarged glass.

Recently, many studies have been made to produce an aligning layer using a novel contact less-type process in order to avoid the above problems of the contact-type rubbing process. Examples of the contactless-type process of producing the aligning layer include an optical alignment process, an energy beam alignment process, a vapor deposition alignment process, and an etching process using lithography. However, the contactless-type aligning layer is difficult to be commercialized due to low thermal stability and residual images as compared to the aligning layer produced using the contact-type rubbing.

In particular, in the case of the photoaligning layer , since thermal stability is significantly reduced and the residual images are maintained for a long time, the photoaligning layer cannot be commercially produced even though convenience of the process is assured.

With respect to improvement in thermal stability, Korean Patent No. 10-0357841 discloses novel linear and cyclic polymers or oligomers of coumarin and quinolinol derivatives having the photoreactive ethene group, and the use of the polymers or the oligomers as the liquid crystal aligning layer. However, the liquid crystal aligning layer according to the patent has problem resulted from residual images due to a rod-shaped mesogen bonded to a main chain.

To avoid the above-mentioned problem regarding the residual images, Korean Patent No. 10-0258847 suggests a liquid crystal aligning layer that is mixed with a thermosetting resin or has a functional group capable of being thermally cured. However, the patent is problematic in that alignment and thermal stability are poor.

It is known that examples of the photoreaction using radiation of ultraviolet rays include the photo-polymerization of cinnamate, coumarin or the like, the photo-isomerization such as cis-trans isomerization, and breaking of the molecular chain due to decomposition. It has been reported that the molecular photoreaction using ultraviolet rays is applied to the alignment of the liquid crystals using the radiation of ultraviolet rays through the desirable design of the aligning layer molecule and optimization of the radiation condition of ultraviolet rays. With respect to the above, many patents have been suggested in LCD industry field of Japan, Korea, Europe, and the U.S.A since the patent of Gibbons and Schadt had been announced in the year 1991. However, the above-mentioned technologies are not applied to LCDs even after 15 years that the initial idea was suggested. The reason for this is as follows. Even though the alignment of the liquid crystals may be performed by using the photoreaction, it is impossible to maintain or provide the stable alignment of the liquid crystals against heat, light, physical impact, chemical impact or the like. This is mainly caused by poor anchoring energy, poor stability of the alignment of the liquid crystals, residual images or the like, as compared with the rubbing process.

Most of known studies and patents have been focused on overcoming the above-mentioned problems by design of photosensitive functional groups. To achieve this, there was an attempt to modify molecular structures variously. However, a desirable solution has not been suggested because it is difficult to maintain the stable alignment of liquid crystals by using only photoreaction.

Additionally, the known liquid crystal aligning layer comprising polyimide is subjected to heat treatment and then aligned in both a rubbing process and a process using ultraviolet rays to achieve full imidization of the polyamic acid. However, the liquid crystal aligning layer which is produced by using the above-mentioned procedure is problematic in that thermal stability is significantly reduced and the residual image is continued for a long time.

### DISCLOSURE

### Technical Problem

The present inventors have studied on a liquid crystal aligning layer with excellent thermal stability and no residual image, resulting in the preparing a novel polyimide copolymer and finding that a liquid crystal aligning layer comprising the novel polyimide copolymer has excellent thermal stability, no residual images, and excellent alignment of liquid crystals, thereby accomplishing the present invention.

Accordingly, it is an object of the present invention to provide a novel polyimide copolymer, a method of preparing the polyimide copolymer, a liquid crystal aligning layer comprising the polyimide copolymer, a method of producing the liquid crystal aligning layer, and a liquid crystal display comprising the liquid crystal aligning layer.

### Technical Solution

In order to accomplish the above object, the present invention provides a polyimide copolymer comprising a repeating unit that is represented by the following Formula 1:

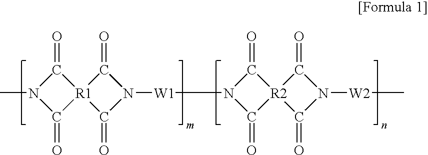

wherein m is more than 0 mole % and less than 100 mole %, n is less than 100 mole % and more than 0 mole %,

R1 and R2 are tetravalent organic groups that are different from each other and preferably comprise at least one aromatic or hetero ring, and

W1 and W2 are the same as or different from each other and are each independently selected from the group consisting of the following Structural formulae:

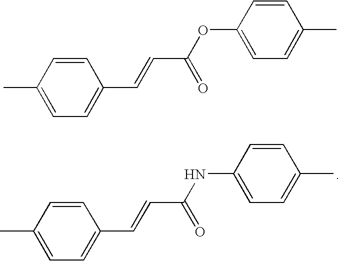

Said R1 and R2 may be each independently selected from the group consisting of the following Structural formulae.

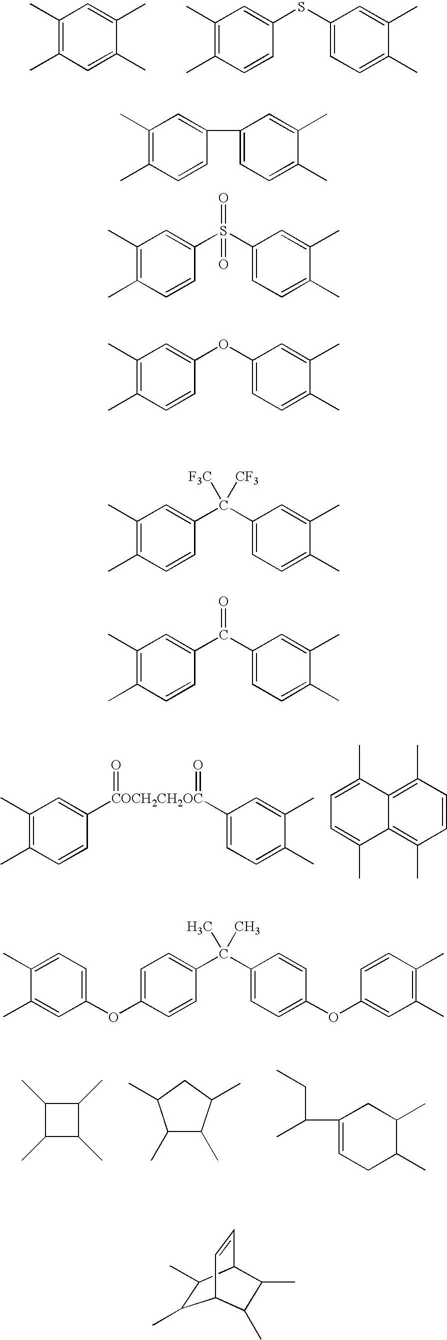

In addition, the present invention provides a polyimide copolymer that is represented by the following Formula 2:

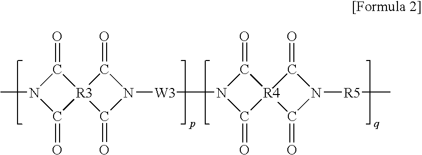

wherein p is 1 mole % or more and less than 100 mole %, q is 99 mole % or less and more than 0 mole %,

R3 and R4 are tetravalent organic groups that are the same as or different from each other and preferably comprise at least one aromatic or hetero ring,

W3 is selected from the group consisting of the following Structural formulae:

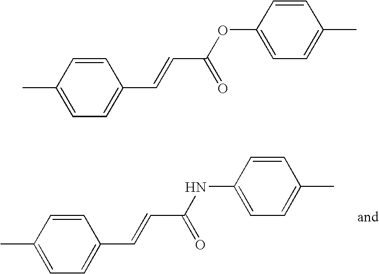

R5 is a divalent organic group and preferably a divalent organic group that includes at least one aromatic ring.

Said R3 and R4 may be each independently selected from the group consisting of the following Structural formulae.

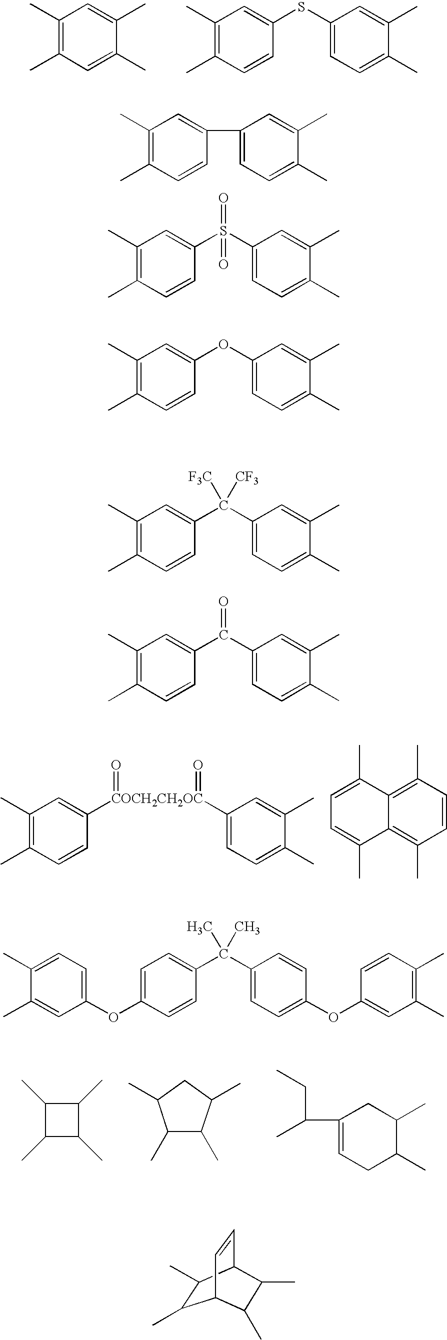

Said R5 may be each independently selected from the group consisting of the following Structural formulae.

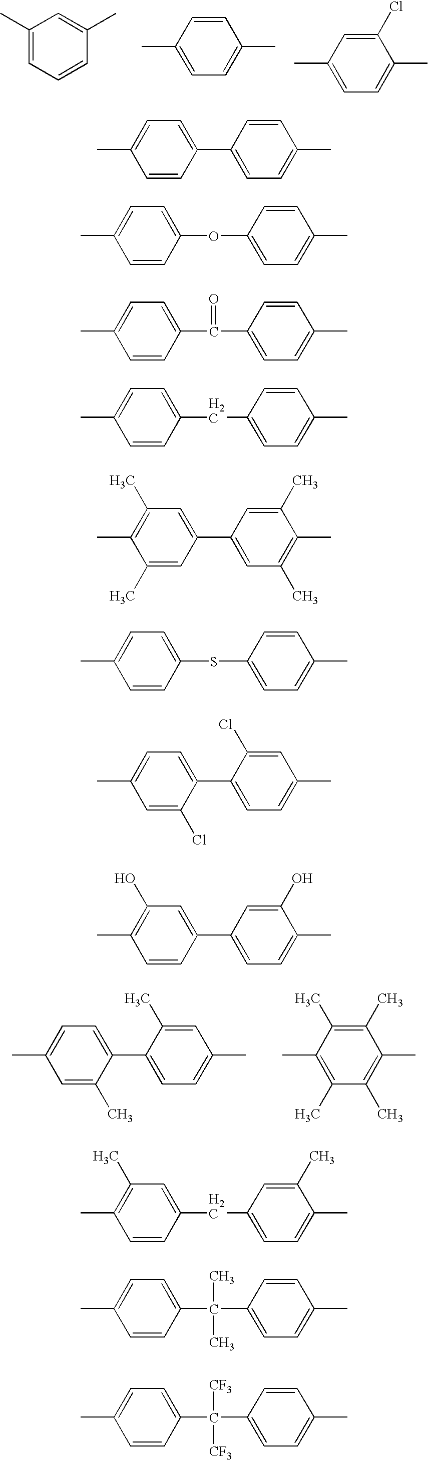

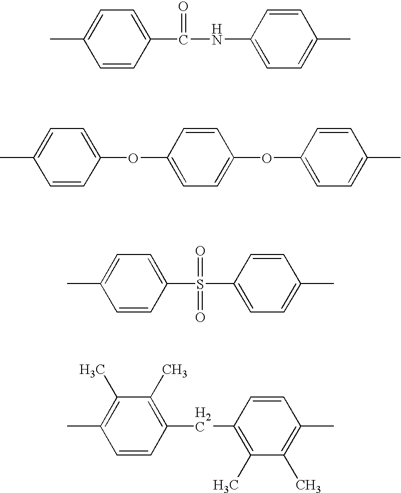

Furthermore, the present invention provides a method of preparing a polyimide copolymer that is represented by the above Formula 1 or 2.

Furthermore, the present invention provides a liquid crystal aligning layer that comprises the above polyimide copolymer and a method of producing the liquid crystal aligning layer.

Furthermore, the present invention provides a liquid crystal display that comprises the above liquid crystal aligning layer.

### Advantageous Effects

A liquid crystal aligning layer that comprises a polyimide copolymer according to the present invention has excellent thermal stability, no residual images, and excellent alignment of liquid crystals.

Additionally, in the case of a liquid crystal aligning layer that is produced by using a method according to the present invention, ultraviolet rays are radiated on movable chains of the polyamic acid copolymer to perform alignment before a polyimide copolymer is imidized, and heat treatment is then performed to conduct imidization. Thus, thermal stability is excellent, residual images are not formed, and alignment of liquid crystals is excellent.

### DESCRIPTION OF DRAWINGS

FIG. 1 is a view illustrating thermal stability of a liquid crystal aligning layer of Example 2 according to the present invention; and

FIG. 2 is a view illustrating alignment of liquid crystals of the liquid crystal aligning layer that is produced by using a method according to Example 1 in the present invention and by using a known method in Comparative Example 1.

### BEST MODE

Hereinafter, the present invention will be described in detail by using an example of a photosensitive resin composition according to the present invention, but the scope of the present invention is not limited to the following example.

Both ends of a polyimide copolymer represented by the above Formula 1 or 2 may be capped by the following Structural formulae:

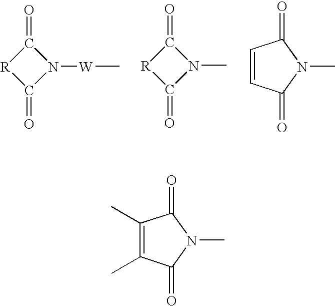

wherein, R is selected from the group consisting of the following Structural formulae, and

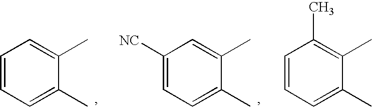

W is selected from the group consisting of the following Structural formulae.

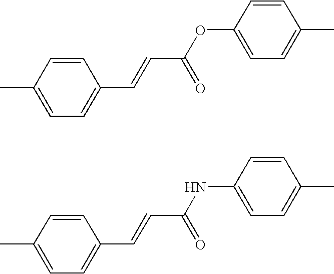

A polyimide copolymer which is represented by the above Formula 1 according to the present invention may be prepared by using at least two dianhydride compounds which are represented by the following Formula 3 and at least one diamine compound which is represented by the following Formula 4. In addition, the polyimide copolymer which is represented by the above Formula 2 may be prepared by using at least two dianhydride compounds which are represented by the following Formula 3, at least one diamine compound which is represented by the following Formula 4, and at least one diamine compound which is represented by the following Formula 5. The other reaction conditions may be conditions known in the art.

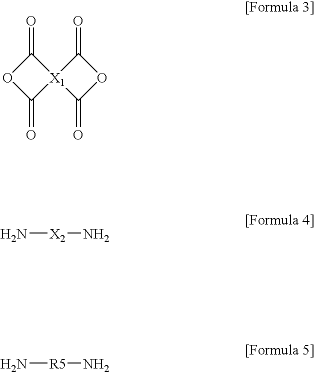

In the above Formula 3, X₁ is a tetravalent organic group and is selected from the group consisting of the following Structural formulae.

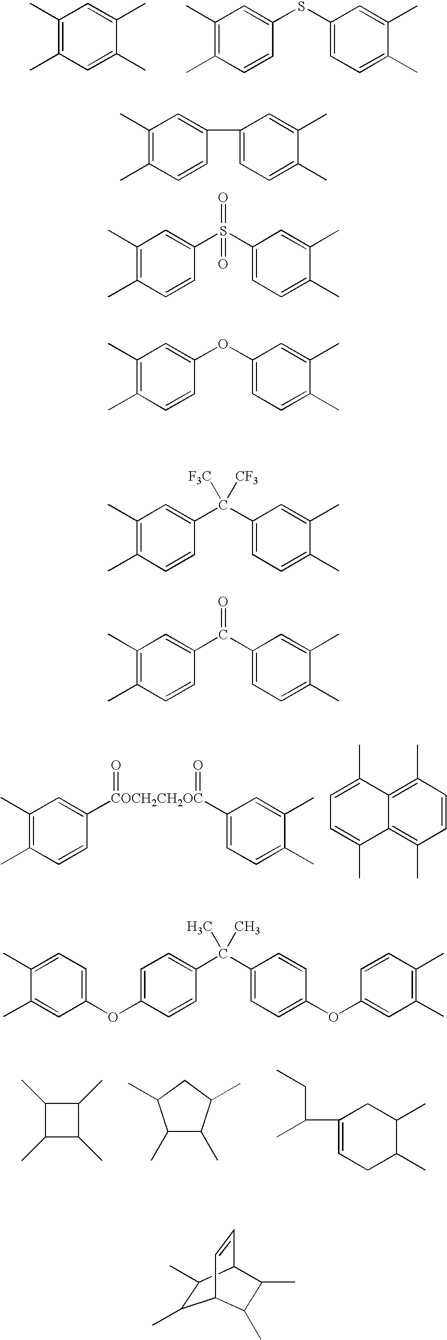

In the above Formula 4, X₂ is selected from the group consisting of the following Structural formulae.

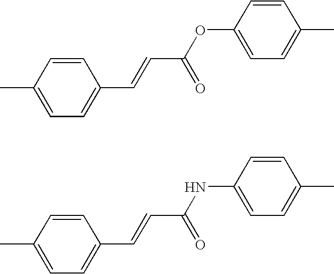

In the above Formula 5, R5 is a divalent organic group and is selected from the group consisting of the following Structural formulae.

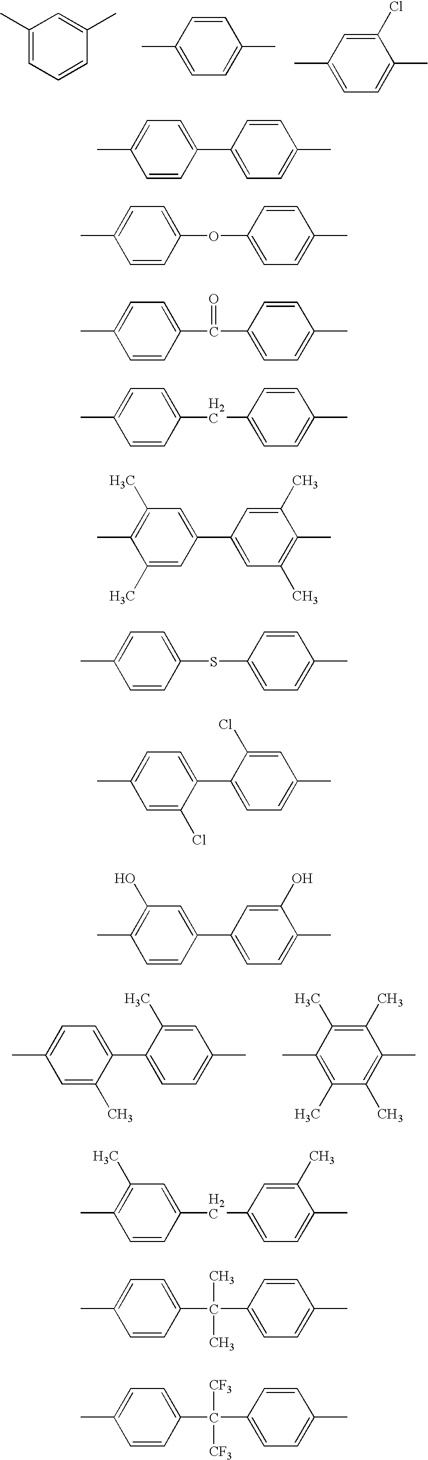

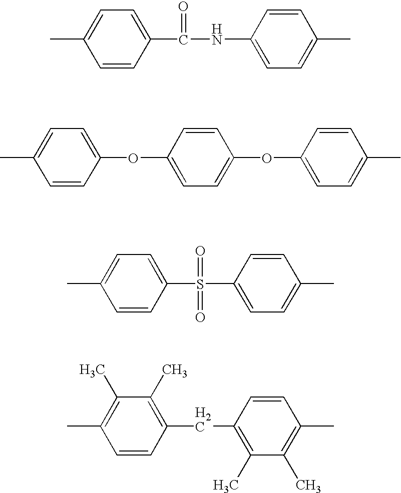

Examples of the dianhydride compound which is represented by the above Formula 3 include, but are not limited to PMDA (pyromellitic dianhydride), CBDA (cyclobutane-1,2,3,4-tetracarboxylic dianhydride), BPDA (3,3′,4,4′-biphenyltetra-carboxylic dianhydride), ODPA (4,4′-oxydiphthalic anhydride) or the like.

Examples of the diamine compound which is represented by the above Formula 4 include, but are not limited to ODA (4,4′-oxydianiline), DMMDA (3,3′-dimethyl-4,4′-methylene dianiline), MDA (4,4′-methylenedianiline) or the like.

The polyimide copolymer according to the present invention is characterized in that the copolymer comprises at least two selected from dianhydride and diamine.

Properties such as coating property and alignment stability, which are difficult to be obtained by using a homopolymer that comprises one type of dianhydride and one type of diamine, may be improved by using the polyimide copolymer according to the present invention.

In addition, the present invention provides a liquid crystal aligning layer that comprises the polyimide copolymer which is represented by the above Formula 1 or 2.

A method of producing a liquid crystal aligning layer according to the present invention comprises:

1) dissolving a polyamic acid copolymer which is represented by the following Formula 6 or 7 in an organic solvent to prepare a liquid crystal alignment solution, and applying the above liquid crystal alignment solution on a surface of a substrate to form a coat layer,

2) drying over the solvent that is contained in the above coat layer,

3) radiating polarized ultraviolet rays on the dried coat layer to perform alignment, and

4) performing heat treatment of the coat layer that is undergone alignment treatment to perform imidization.

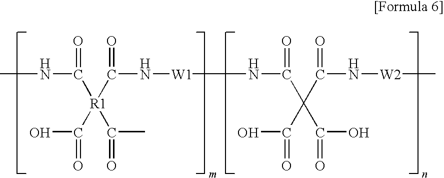

In the above Formula 6,

m is more than 0 mole % and less than 100 mole %, n is less than 100 mole % and more than 0 mole %,

R1 and R2 are different tetravalent organic groups and are each independently selected from the group consisting of the following Structural formulae,

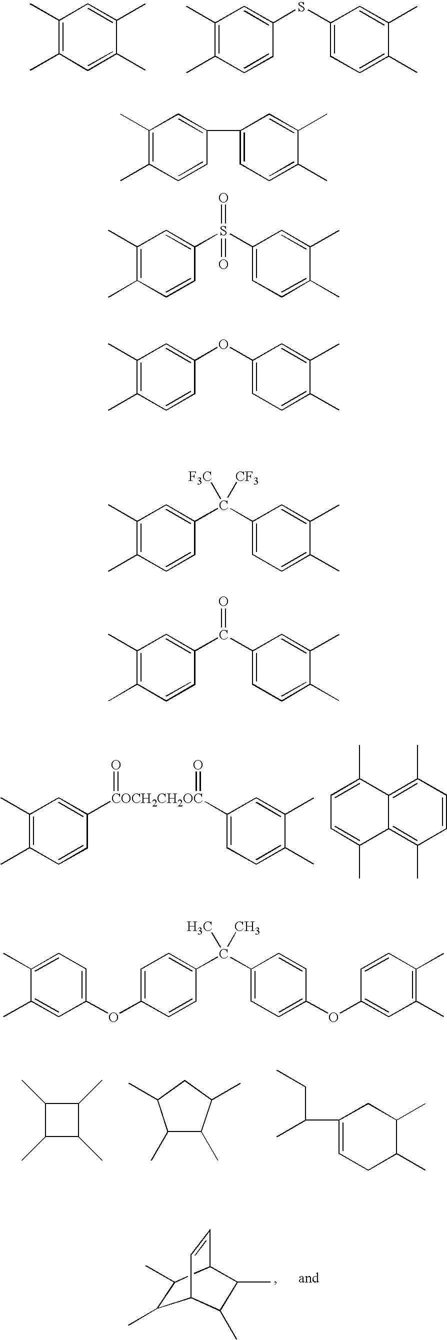

W1 and W2 are the same as or different from each other and each independently selected from the group consisting of the following Structural formulae.

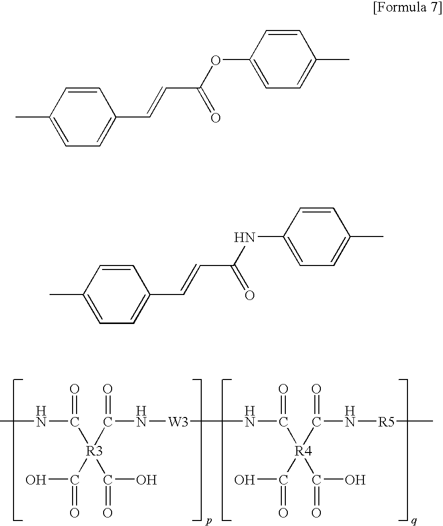

In the above Formula 7,

p is 1 mole % or more and less than 100 mole %, and q is 99 mole % or less and more than 0 mole %,

R3 and R4 are tetravalent organic groups that are the same as or different from each other and each independently selected from the group consisting of the following Structural formulae,

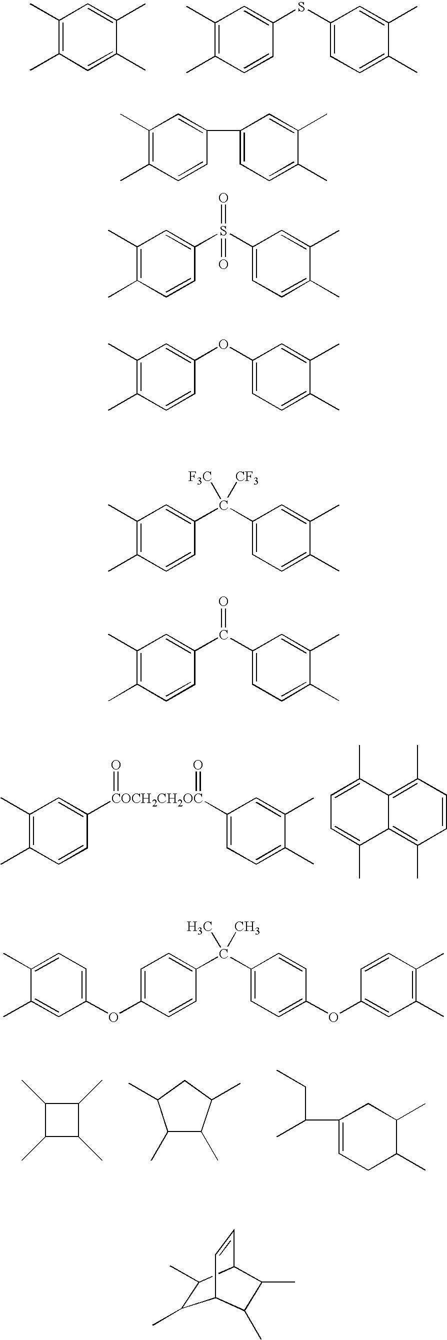

W3 is selected from the group consisting of the following Structural formulae,

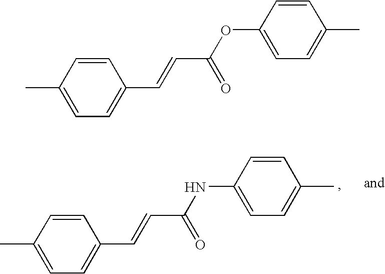

R5 is a divalent organic group and is selected from the group consisting of the following Structural formulae.

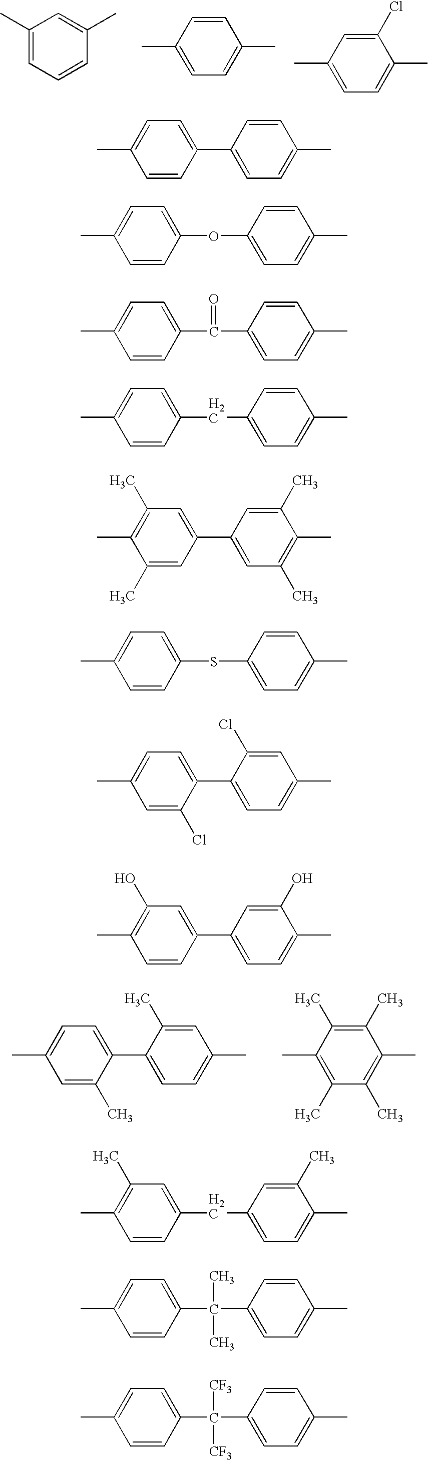

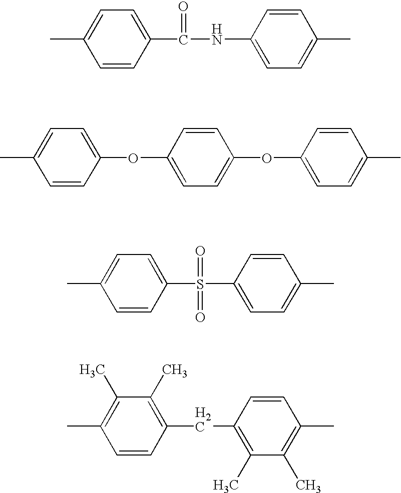

Both ends of the polyamic acid copolymer which is represented by the above Formula 6 or 7 may be capped by the following Structural formulae;

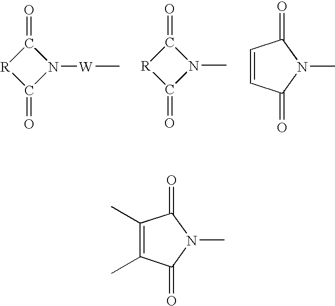

wherein, R is selected from the group consisting of the following Structural formulae,

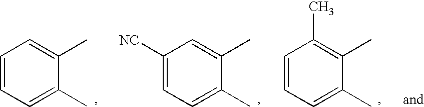

W is selected from the group consisting of the following Structural formulae.

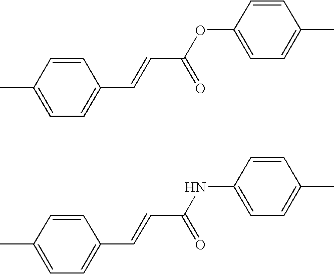

The method of producing the liquid crystal aligning layer according to the present invention will be described in detail.

In the above step 1), the concentration of liquid crystal alignment solution, the type of solvent, and the type of coating process may depend on the type and the use of polyamic acid copolymer which is represented by the above Formula 6 or 7.

In the above step 1), examples of the organic solvent include, but are not limited to cyclopentanone, cyclohexanone, N-methylpyrrolidone, DMF (dimethylformamide), THF (tetrahydrofuran), CCl₄, a mixture thereof and the like.

Additionally, after the coating is performed, in order to assure uniformity of the thickness of the liquid crystal aligning layer and to prevent printing defects, a solvent such as ethylene glycol monoethyl ether acetate, ethylene glycol monoisopropyl ether, or ethylene glycol monomethyl ether may be used in combination with the above-mentioned organic solvent.

In the above step 1), the liquid crystal alignment solution may be applied on a surface of a substrate on which a transparent conductive layer or a metal electrode is patterned by using a process such as a roll coater process, a spinner process, a printing process, an inkjet spray process, and a slit nozzle process.

In addition, during the application of the liquid crystal alignment solution, in order to improve adhesion of the liquid crystal alignment solution to the surface of the substrate, the transparent conductive layer, the metal electrode, and the coat layer, a functional silane-containing compound, a functional fluorine-containing compound, and a functional titanium-containing compound may be applied on the substrate in advance.

During the production of the liquid crystal alignment solution in the above step 1), the temperature is in the range of 0 to 100° C., and preferably 15 to 70° C.

In the above step 2), the solvent may be dried over by using the heating of the coat layer, a vacuum vaporization process or the like.

In the case of when the solvent is dried over during the above step 2), the drying may be performed at the temperature in the range of 35 to 80° C., and preferably 50 to 75° C. within 1 hour.

If the substrate is heated at the temperature that is more than 80° C. while the solvent is dried, since the imidization reaction of the polyamic acid copolymer is performed before the alignment treatment process, the alignment efficiency of liquid crystals may be reduced after the alignment treatment process. Therefore, in the method of producing the liquid crystal aligning layer according to the present invention, only the solvent contained in the coat layer after the application of the liquid crystal alignment solution is subjected to heat treatment or vacuum vaporization. Thereby, the polyamic acid copolymer is present without being polyimidized.

In the above step 3), ultraviolet rays having a wavelength in the range of 150 to 450 nm may be radiated on the dried coat layer that is formed in the above step 2) to perform the alignment treatment. In connection with this, the intensity of exposure depends on the type of polyamic acid copolymer that is represented by the above Formula 6 or 7, and energy of 50 mJ/cm² to 10 J/cm², and preferably 500 mJ/cm² to 5 J/cm², may be radiated thereon.

The alignment treatment is performed by the radiation of polarized ultraviolet rays that are selected from ultraviolet rays which are polarized by means of transmission or reflection of the ultraviolet rays through \textcircled{1} a polarizing device using a transparent substrate, such as quartz glass, soda lime glass, and soda lime-free glass, a surface of which is coated with a dielectric isotropic material, CD a polarizing plate on which aluminum or metal wires are finely deposited, CD a Brewster polarizing device using reflection of quartz glass or the like. In connection with this, the polarized ultraviolet rays may be perpendicularly radiated on the substrate, or inclinedly at a predetermined angle. Through the above-mentioned method, the desirable alignment of liquid crystal molecules is provided to the coat layer.

In the above step 3), it is preferable that the temperature of the substrate be normal temperature when the ultraviolet rays are radiated. However, the ultraviolet rays may be radiated while the substrate is heated at the temperature in the range of 80° C. or less if necessary.

In the above step 4), the coat layer in which the liquid crystals are aligned by the radiation of the polarized ultraviolet rays may be heated at the temperature in the range of 80 to 300° C., and preferably 115 to 300° C., for 15 min or more to perform stabilization. The polyamic acid copolymer is subjected to ring-closing dehydration through the above-mentioned heat treatment process to be converted into a polyimide copolymer which is represented by the above Formula 1 or 2.

In the liquid crystal aligning layer that is prepared after the above step 4), the concentration of the solid of the polyimide copolymer which is represented by the above Formula 1 or 2 is selected in consideration of the molecular weight, the viscosity, the volatility or the like of the polyamic acid copolymer which is represented by the above Formula 5 or 6, and preferably selected in the range of 0.5 to 20% by weight. In this case, the concentration of the solid of polyimide varies according to the molecular weight of the polyamic acid copolymer. But in the case that the concentration of the solid of polyimide is 0.5% by weight or less, even though the molecular weight of the prepared polyamic acid copolymer is sufficiently high, it is difficult to obtain the desirable alignment of liquid crystals since the thickness of the liquid crystal aligning layer is very small. And in the case that the concentration is more than 20% by weight , since the viscosity of the liquid crystal alignment solution is excessively increased, the coating property is easily deteriorated, and the thickness of the liquid crystal aligning layer is very large. Thus, it is difficult to obtain the desirable alignment of liquid crystals.

The thickness of the final coat layer that is formed through the above-mentioned procedure is in the range of 0.002 to 2 μm. It is more preferable that the thickness be in the range of 0.004 to 0.6 μm in order to produce the desirable liquid crystal display device.

After the above-mentioned procedure is performed, it is possible to produce a photoaligning layer having the liquid crystal alignment ability, which is stable in respects to external heat and physical and chemical impacts.

The liquid crystal aligning layer according to the present invention may include typical solvents or additives that are known in the art in addition to the above polyimide copolymer.

In the case of the liquid crystal aligning layer that is produced by using the method according to the present invention, ultraviolet rays are radiated on movable chains of the polyamic acid copolymer to perform alignment before the polyimide copolymer is imidized, and heat treatment is then performed to conduct imidization. Thus, thermal stability is excellent, residual images are not formed, and alignment of liquid crystals is excel lent as compared to a known method that includes radiating ultraviolet rays after the imidization is performed.

Additionally, the present invention provides a liquid crystal display that comprises the above liquid crystal aligning layer.

The above liquid crystal display may be produced by using a typical method that is known in the art.

The liquid crystal display that comprises the liquid crystal aligning layer according to the present invention has excellent thermal stability and no residual images.

### MODE FOR INVENTION

A better understanding of the present invention may be obtained in light of the following Examples and Comparative Examples which are set forth to illustrate, but are not to be construed to limit the present invention.

### EXAMPLE 1

1) Preparation of the Polyamic Acid Copolymer

2.5045 g (0.0098 mole) of (4′-aminophenyl)-4-aminocinnamate and 37 mL of NMP (N-Methyl-2-pyrrolidone) were put into the reactor provided with the agitator. After the solid diamine was completely dissolved in NMP, 1.0741 g (0.0049 mole) of PMDA (Pyromellitic dianhydride) and 0.9658 g (0.0049 mole) of CBDA (cyclobutane-1,2,3,4-tetracarboxylic dianhydride) were added in a solid mixture at room temperature at a time, and then continuously agitated for 20 hours to obtain a viscous polyamic acid copolymer solution having an intrinsic viscosity of 1.58 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The polyamic acid copolymer which was prepared in the 1) was dissolved in a mixture solution of NMP and butoxy ethanol which was mixed with each other at a mixing ratio of 80:20 to prepare the liquid crystal alignment solution in which the content of the solid of the polyamic acid copolymer was 4%.

3) Preparation of the Liquid Crystal Aligning Layer

The liquid crystal alignment solution which was prepared in the 2) was applied on the substrate, and the above substrate was dried at 80° C. for 1 hour to remove the solvent. Next, the polarized ultraviolet rays were radiated to perform the alignment treatment, and the heat treatment process was performed at 150° C. for 1 hour and at 230° C. for 30 min to perform imidization to finish the product ion of the liquid crystal aligning layer.

IR (film, silicon wafer): 1861, 1781, 1727, 1635, 1382, 724 cm⁻¹.

### EXAMPLE 2

1) Preparation of the Polyamic Acid Copolymer

5.6739 g (0.0224 mole) of (4′-aminophenyl)-4-aminocinnamate and 81 mL of NMP were put into the reactor provided with the agitator. After the solid diamine was completely dissolved in NMP, 3.9043 g (0.0179 mole) of PMDA and 1.3210 g (0.00449 mole) of BPDA (3,3′,4,4′-biphenyltetra-carboxylic dianhydride) were added in a solid mixture at 0° C. at a time. After 30 min, the agitation was continued at room temperature for 20 hours to obtain a viscous polyamic acid copolymer solution having an intrinsic viscosity of 1.32 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as 3) of the above Example 1.

IR (film, silicon wafer): 1850, 1775, 1724, 1679, 1626, 1376, 739 cm⁻¹.

### EXAMPLE 3

1) Preparation of the Polyamic Acid Copolymer

2.7520 g (0.0108 mole) of (4′-aminophenyl)-4-aminocinnamate and 51 mL of NMP were put into the reactor provided with the agitator. After the solid diamine was completely dissolved in NMP, 1.7667 g (0.0081 mole) of PMDA and 0.5025 g (0.0016 mole) of ODPA (4,4′-oxydiphthalic anhydride) were added to the mixture at the same time. The reaction mixture was agitated at ambient temperature for 4 hours, and 0.3259 g (0.0022 mole) of the phthalic anhydride endcapper was added thereto. The agitation was continued for 20 hours to obtain a viscous polyamic acid copolymer solution having an intrinsic viscosity of 0.56 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as 3) of the above Example 1.

IR (film, silicon wafer): 1846, 1779, 1724, 1635, 1378, 725 cm⁻¹.

### EXAMPLE 4

1). Preparation of the Polyamic Acid Copolymer

0.2554 g (0.001 mole) of (4′-aminophenyl)-4-aminocinnamate, 0.2011 g (0.001 mole) of ODA (4,4′-oxydianiline), and 7 mL of NMP were put into the reactor provided with the agitator. After the solid diamine was completely dissolved in NMP, 0.4082 g (0.002 mole) of PMDA was added to the mixture at a time. The agitation was continued at room temperature for 20 hours to obtain a viscous polyamic acid copolymer solution having an intrinsic viscosity of 1.44 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as 3) of the above Example 1.

IR (film, silicon wafer): 1859, 1778, 1725, 1634, 1379, 724 cm⁻¹.

### EXAMPLE 5

1) Preparation of the Polyamic Acid Copolymer

0.7819 g (0.0031 mole) of (4′-aminophenyl)-4-aminocinnamate, 0.2011 g (0.001 mole) of DMMDA (3,3′-dimethyl-4,4′-methylene and 13 mL of NMP were put into the reactor provided with the agitator. After the solid diamine was completely dissolved in NMP, 0.8416 g (0.00386 mole) of PMDA was added to the mixture at a time. The agitation was continued at room temperature for 20 hours to obtain .a viscous polyamic acid copolymer solution having an intrinsic viscosity of 1.97 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as 3) of the above Example 1.

IR (film, silicon wafer): 1861, 1778, 1728, 1682, 1629, 1375, 727 cm⁻¹.

### EXAMPLE 6

1) Preparation of the Polyamic Acid Copolymer

0.9879 g (0.0039 mole) of (4′-aminophenyl)-4-aminocinnamate, 0.3300 g (0.0017 mole) of MDA (4,4′-methylenedianiline), and 25 mL of NMP were put into the reactor provided with the agitator. After the solid diamine was completely dissolved in NMP, 1.6356 g (0.0053 mole) of OPDA was added to the mixture at a time. The reaction mixture was agitated at ambient temperature for 4 hours, and 0.0899 g (0.0005 mole) of the 3-methylphthalic anhydride endcapper was added thereto. The agitation was continued at room temperature for 20 hours to obtain a viscous polyamic acid copolymer solution having an intrinsic viscosity of 0.60 dL/g. The above polyamic acid copolymer solution was filtered by using a poly(tetrafluoroethylene) filter (pore size=1.0 μm) to obtain the polyamic acid copolymer.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as 3) of the above Example 1.

IR (film, silicon wafer): 1849, 1777, 1718, 1632, 1375, 745 cm⁻⁴.

### EXAMPLE 7

1) Preparation of the Polyamic Acid Copolymer

In respects to the method of preparing (1) the polyamic acid of the above Example 1, the same procedure was performed to prepare the copolymer, except that (4′-aminophenyl)-4-aminocinnamaide was used instead of (4′-aminophenyl)-4-aminocinnamate.

The molecular weight of the resulting copolymer was confirmed by using a GPC. The number average molecular weight (Mn) was 42,000 and the weight average molecular weight (Mw) was 95,000.

2) Preparation of the Liquid Crystal Alignment Solution

The liquid crystal alignment solution was prepared by using the same procedure as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same procedure as (3) of the above Example 1.

### COMPARATIVE EXAMPLE 1

The preparation of the polyamic acid copolymer and the production of the liquid crystal alignment solution were performed by using the same method as that of the above Example 1. The prepared liquid crystal alignment solution was applied on the substrate, and the above substrate was heated at 80° C. for 3 min and additionally heated at 230° C. for 1 hour to finish the reaction of the polyimidization of the polyamic acid. Next, the polarized ultraviolet rays were radiated to perform the alignment, thereby accomplishing the liquid crystal aligning layer.

### COMPARATIVE EXAMPLE 2

1) Preparation of the Polyamic Acid Copolymer

The same method as that of preparing the 1) polyamic acid of the above Example 1 was performed to prepare the copolymer of Comparative Example 2, except that 2.5045 g (0.0098 mole) of (4′-aminophenyl)-4-aminocinnamate and 2.1482 g (0.0049 mole) of PMDA (Pyromellitic dianhydride) were only used while 2.5045 g (0.0098 mole) of (4′-aminophenyl)-4-aminocinnamate), 1.0741 g (0.0049 mole) of PMDA (Pyromellitic dianhydride), and 0.9658 g (0.0049 mole) of CBDA (cyclobutane-1,2,3,4-tetracarboxylic dianhydride) were not used.

The molecular weight of the obtained copolymer was confirmed by using the GPC. In result, the number average molecular weight (Mn) was 37,000 and the weight average molecular weight (Mw) was 88,000.

2) Preparation of the Liquid Crystal Alignment Solution

The liquid crystal alignment solution was prepared by using the same method as 2) of the above Example 1, except that the polyamic acid copolymer prepared in 1) was used instead of the polyamic acid copolymer of the above Example 1.

3) Preparation of the Liquid Crystal Aligning Layer

The liquid crystal aligning layer was produced by using the liquid crystal alignment solution prepared in 2) according to the same method as 3) of the above Example 1.

<Evaluation of Thermal and Ultraviolet Ray Stabilities of the Liquid Crystal Aligning Layer>

The following experiment was performed in order to confirm the thermal stability of the liquid crystal aligning layer according to the present invention.

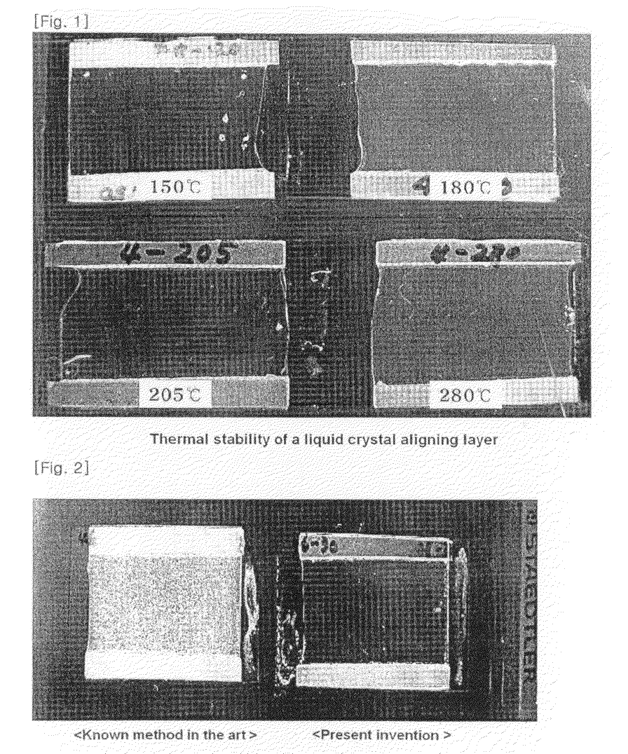

During the production of the liquid crystal aligning layer of the above Example, after the liquid crystal alignment solution was applied on the substrate, the solvent was dried, the exposure treatment was performed by using the ultraviolet rays, and the heat treatment was conducted. After the single substrate was subjected to the heat treatment at 150° C., 180° C., 205° C., and 280° C. for 1 hour, the thermal stability of the single substrate was evaluated by using the alignment state of the liquid crystal, and the results are described in Table 1. In addition, the thermal stability of the liquid crystal aligning layer according to Example 2 is shown in FIG. 1.

As shown in Table 1 and FIG. 1, the liquid crystal aligning layer according to the present invention maintained the desirable alignment state of the liquid crystal even after the heat treatment is performed at the above temperature for 1 hour.

Additionally, the alignment properties of the liquid crystals of the liquid crystal aligning layer which was produced by performing the imidization after the ultraviolet rays treatment in a polyamic acid copolymer state according to the present invention and by performing the maximum imidization of a known polyamic acid and then conducting the ultraviolet rays treatment in a polyimide state in Comparative Example 1 were compared to each other, and the results are shown in Table 1 and

FIG. 2. As shown in Table 1 and FIG. 2, the liquid crystal aligning layers of Examples according to the present invent ion had the very high stability in respects to the radiation of the ultraviolet rays.

<Evaluation of the Coating Property of the Liquid Crystal Aligning Layer>

The coating properties of the liquid crystal aligning layer according to the present invention and the Comparative Example were observed by using a microscope and compared to each other. In Comparative Example 2, during the preparation of the liquid crystal aligning layer, the solution was applied on the substrate, dried at 80° C. for 1 hour to remove the solvent, and the coating property of the aligning layer was observed. As shown in Table 1, many poor finely coated portions were observed in Comparative Example 2, but in the case of the aligning layer of Example including the copolymer according to the present invention, a very desirable state was ensured without the poor coated portions.

TABLE 1

| | | Alignment state | | | | | |
|---|---|---|---|---|---|---|---|
| | | | | | | Ultraviolet rays | |
| | Initial | 150° C./ | 180° C./ | 205° C./ | 280° C./ | After | Coating |
| Sample | stage | 1 hr | 1 hr | 1 hr | 1 hr | treatment | property |
| Example 1 | Fair | Fair | Fair | Fair | Fair | Fair | Fair |
| Example 2 | Fair | Fair | Fair | Fair | Fair | Fair | Fair |
| Example 3 | Fair | Fair | Fair | Fair | Fair | Fair | Fair |
| Example 4 | Fair | Fair | Fair | Fair | Fair | Fair | Fair |
| Example 5 | Fair | Fair | Fair | Fair | Fair | Fair | Fair |
| Example 6 | Fair | Fair | Fair | Fair | Fair | Fair | Fair |
| Example 7 | Fair | Fair | Fair | Fair | Fair | Fair | Fair |
| Comparative | Poor | Poor | Poor | Poor | Poor | Poor | Fair |
| Example 1 | | | | | | | |
| Comparative | Fair | Fair | Fair | Fair | Fair | Fair | Poor |
| Example 2 | | | | | | | |

Fair: A state that there is no poor liquid crystal alignment in a liquid crystal cell
Poor: A state that poor liquid crystal alignment is apparently observed in a liquid crystal cell.

1. A polyimide copolymer comprising a repeating unit that is represented by the following Formula 1: 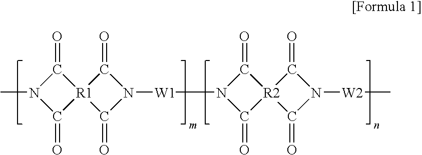
wherein m is more than 0 mole % and less than 100 mole %, n is less than 100 mole % and more than 0 mole %,
R1 and R2 are tetravalent organic groups that are different from each other, and
W1 and W2 are the same as or different from each other and are each independently selected from the group consisting of the following Structural formulae:

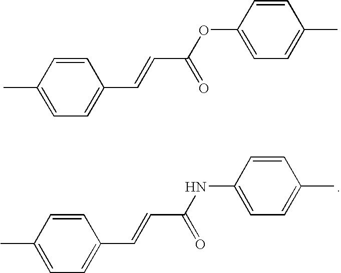

2. The polyimide copolymer as set forth in claim 1, wherein R1 and R2 of the above Formula 1 are each independently selected from the group consisting of the following Structural formulae.

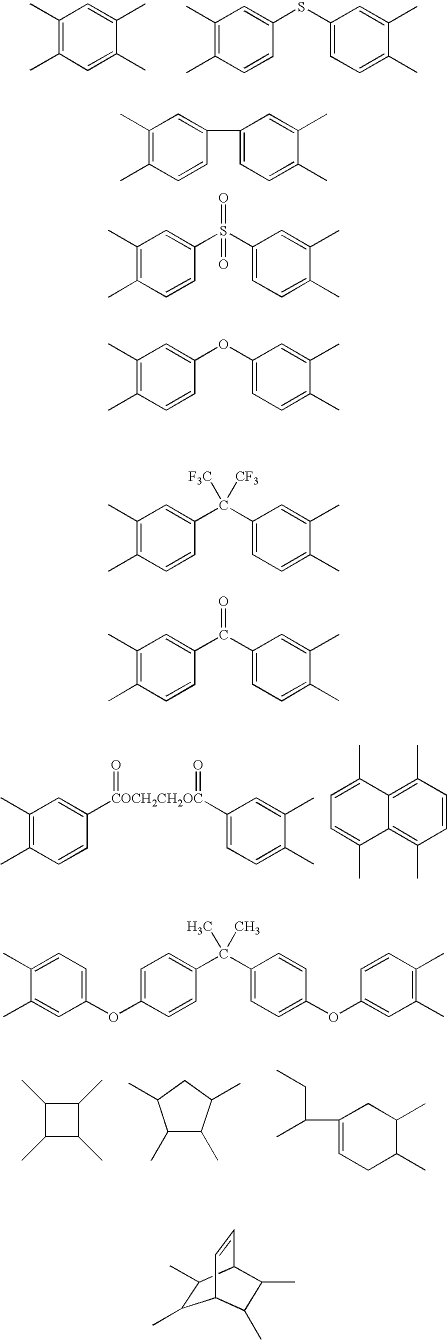

3. The polyimide copolymer as set forth in claim 1, wherein both ends of the polyimide copolymer that is represented by the above Formula 1 are capped by the following Structural formulae: 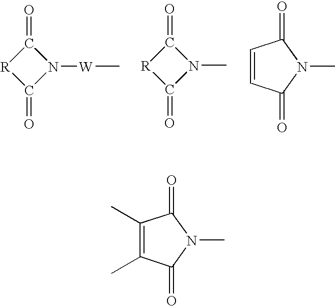
wherein R is selected from the group consisting of the following Structural formulae: 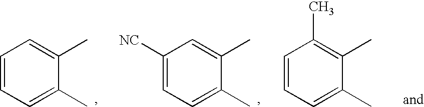
W is selected from the group consisting of the following Structural formulae:

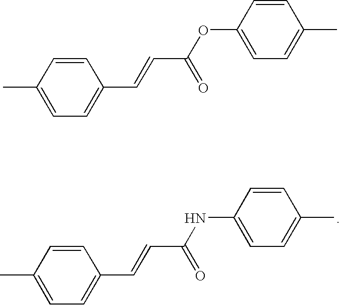

4. A polyimide copolymer comprising a repeating unit that is represented by the following Formula 2: 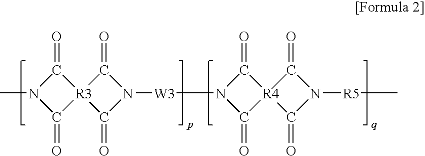
wherein p is 1 mole % or more and less than 100 mole %, q is 99 mole % or less and more than 0 mole %,
R3 and R4 are tetravalent organic groups that are the same as or different from each other,
W3 is selected from the group consisting of the following Structural formulae: 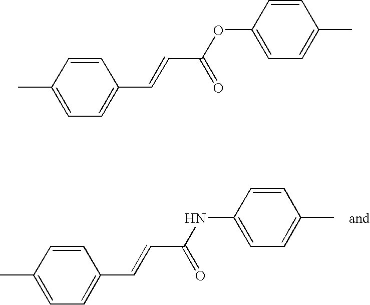
R5 is a divalent organic group.

5. The polyimide copolymer as set forth in claim 4, wherein R3 and R4 of the above Formula 2 are each independently selected from the group consisting of the following Structural formulae: 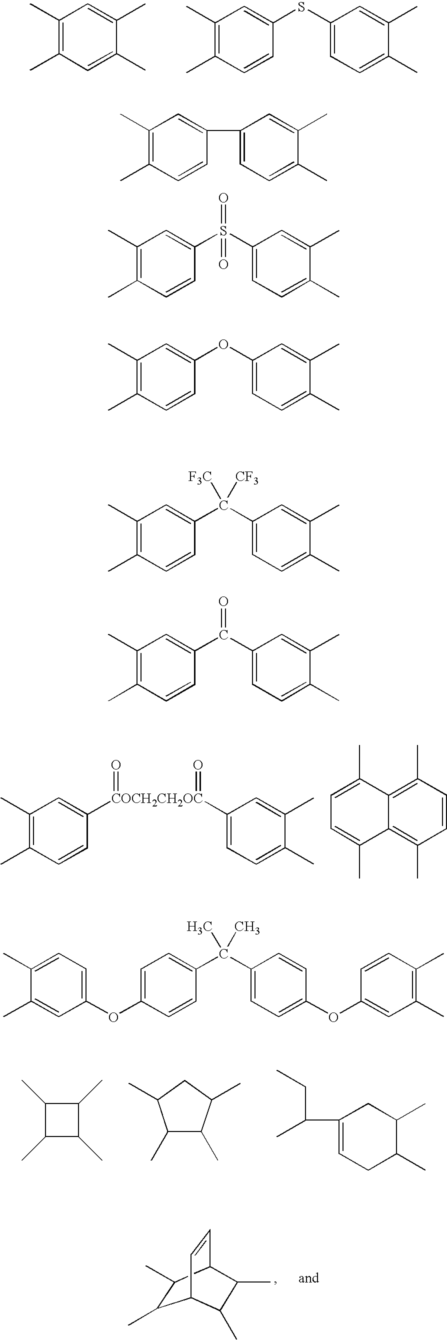
R5 is selected from the group consisting of the following Structural formulae:

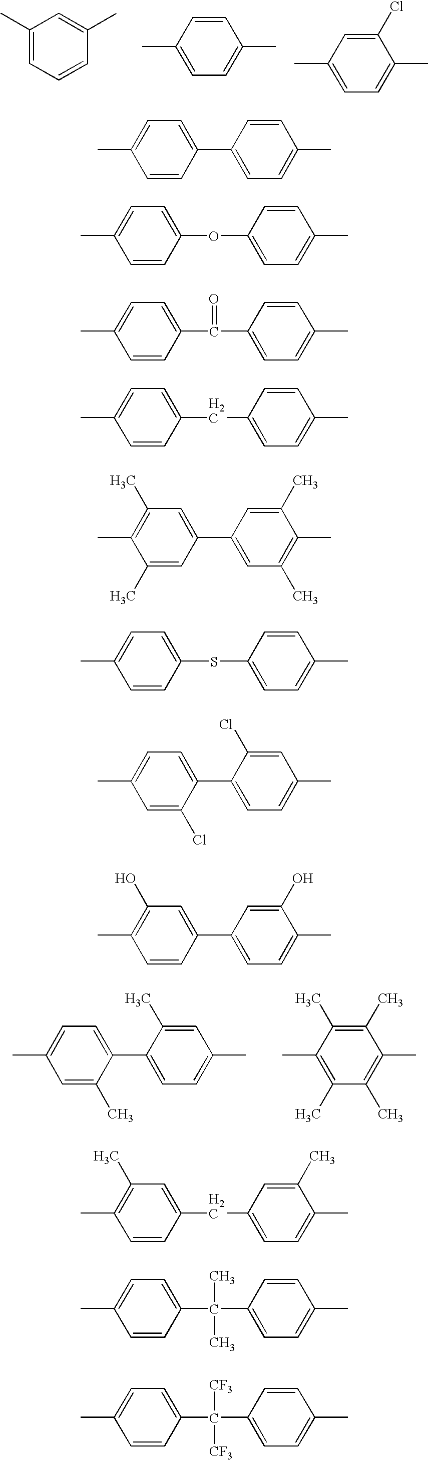

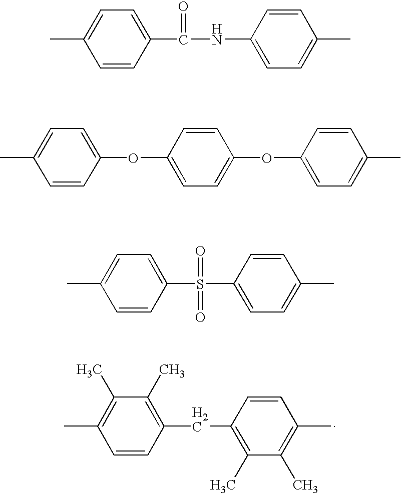

6. The polyimide copolymer as set forth in claim 4, wherein both ends of the polyimide copolymer represented by the above Formula 2 are capped by the following Structural formulae: 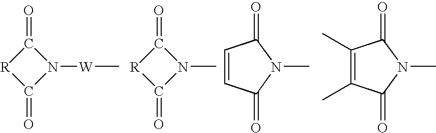
wherein R is selected from the group consisting of the following Structural formulae: 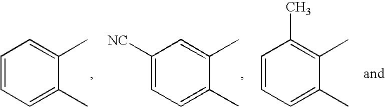
W is selected from the group consisting of the following Structural formulae:

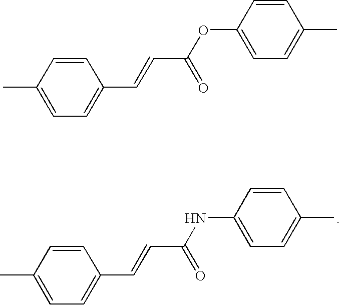

7. A method of preparing a polyimide copolymer that is represented by Formula 1 by using at least two dianhydride compounds that are represented by the following Formula 3 and at least one diamine compound that is represented by the following Formula 4: 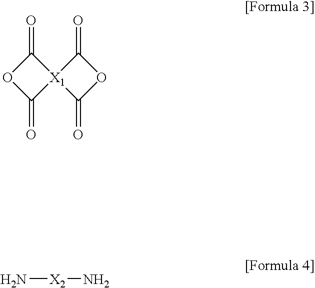
wherein X₁ is a tetravalent organic group, and
X₂ is selected from the group consisting of the following Structural formulae:

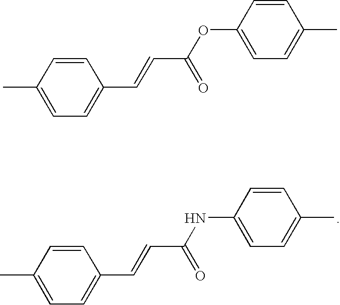

8. A method of preparing a polyimide copolymer that is represented by Formula 2 by using at least two dianhydride compounds that are represented by the following Formula 3, at least one diamine compound that is represented by the following Formula 4, and at least one diamine compound that is represented by the following Formula 5: 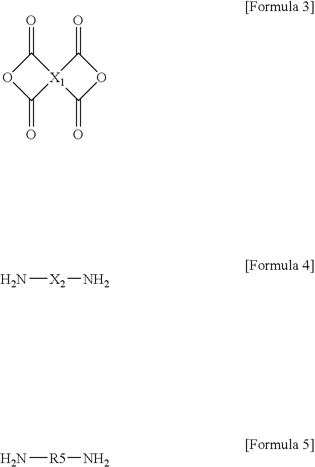
wherein X₁ is a tetravalent organic group, and
X₂ is selected from the group consisting of the following Structural formulae: 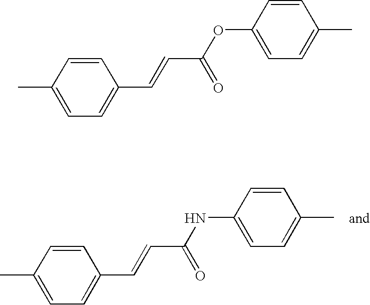
R5 is a divalent organic group.

9. A method of producing a liquid crystal aligning layer, which comprises:
1) dissolving a polyamic acid copolymer that is represented by the following Formula 6 or 7 in an organic solvent to prepare a liquid crystal alignment solution, and applying the liquid crystal alignment solution on a surface of a substrate to form a coat layer;
2) drying the solvent that is contained in the coat layer;
3) radiating polarized ultraviolet rays on a surface of the dried coat layer to perform alignment treatment; and
4) performing heat treatment of the coat layer that is undergone the alignment treatment to perform imidization, 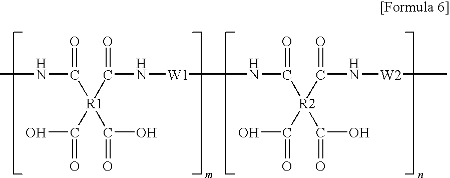
wherein m is more than 0 mole % and less than 100 mole %, n is less than 100 mole % and more than 0 mole %,
R1 and R2 are different tetravalent organic groups,
W1 and W2 are the same as or different from each other and each independently selected from the group consisting of the following Structural formulae: 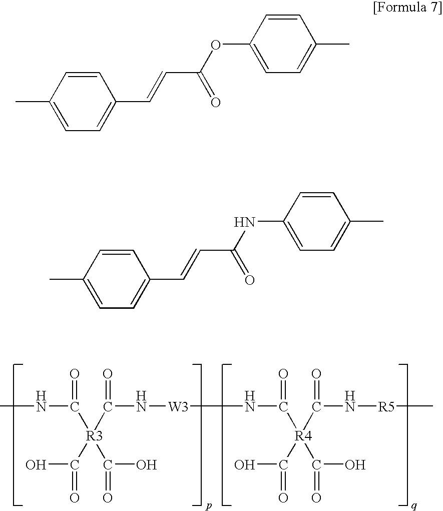
wherein p is 1 mole % or more and less than 100 mole %, and q is 99 mole % or less and more than 0 mole %,
R3 and R4 are tetravalent organic groups that are the same as or different from each other,
W3 is selected from the group consisting of the following Structural formulae: 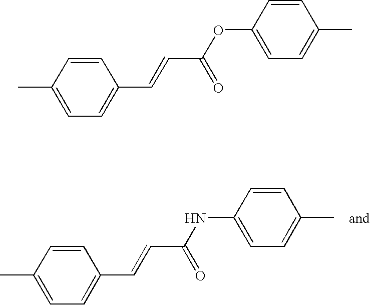
R5 is a divalent organic group.

10. The method of producing a liquid crystal aligning layer as set forth in claim 9, wherein both ends of the polyimide copolymer that is represented by the above Formula 6 or 7 are capped by the following Structural formulae: 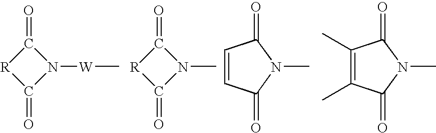
wherein R is selected from the group consisting of the following Structural formulae: 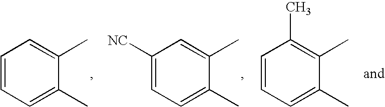
W is selected from the group consisting of the following Structural formulae:

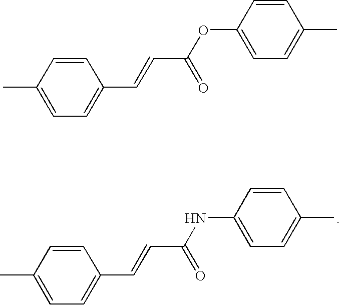

11. The method of producing a liquid crystal aligning layer as set forth in claim 9, wherein said organic solvent is selected from the group consisting of cyclopentanone, cyclohexanone, and N-methylpyrolidone, DMF (Dimethylformamide), THF (Tetrahydrofuran), CCl₄, and a mixture thereof.

12. The method of producing a liquid crystal aligning layer as set forth in claim 11, wherein the organic solvent is used along with an additional organic solvent that is selected from the group consisting of ethylene glycol monoethyl ether acetate, ethylene glycol monoisopropyl ether, and ethylene glycol monomethyl ether.

13. The method of producing a liquid crystal aligning layer as set forth in claim 9, wherein the solvent in the coat layer is dried at 35 to 80° C. within 1 hour in the above step 2.

14. The method of producing a liquid crystal aligning layer as set forth in claim 9, wherein the coat layer that is undergone the alignment treatment is heated at 80 to 300° C. for 15 min or more in the above step 4.

15. A liquid crystal aligning layer comprising the polyimide copolymer according to claim 1.

16. The liquid crystal aligning layer as set forth in claim 15, wherein a layer thickness is in the range of 0.002 to 2 μm.

17. A liquid crystal display comprising the liquid crystal aligning layer according to claim 15.

18. A liquid crystal aligning layer that is produced by using the method according to any one of claims 9.

19. A liquid crystal display comprising the liquid crystal aligning layer according to claim 18.

20. A liquid crystal aligning layer comprising the polyimide copolymer according to claim 4.
